(19) United States
(12) Patent Application Publication
(10) Pub. No.: US 2026/0001092 A1
(43) Pub. Date: Jan. 1, 2026

(54) THERMAL SPRAY BOOTS AND FIXTURE

(71) Applicant: Chromalloy Gas Turbine LLC, Palm Beach Gardens, FL (US)

(72) Inventors: Ethan Alexander SEIFERT, Palm Beach Gardens, FL (US); Joseph Thomas WHITE, Chandler, AZ (US); Joseph John McCOMB, Palm Beach Gardens, FL (US); Roger Dale SEGROVES, Palm Beach Gardens, FL (US)

(21) Appl. No.: 18/757,736

(22) Filed: Jun. 28, 2024

(51) Int. Cl. B05B 12/20; B24C 1/04

(52) U.S. Cl. CPC B05B 12/20; B24C 1/04

(57) ABSTRACT

A masking and support system for a turbine component includes a first resiliently flexible boot configured to cover a first portion of the turbine component. The first resiliently flexible boot includes a concave outer surface and a convex inner surface opposite the outer surface and configured to engage the first portion of the turbine component. A second resiliently flexible boot is configured to cover a second portion of the turbine component. The second resiliently flexible boot includes a convex outer surface and a concave inner surface opposite the outer surface and configured to engage the second portion of the turbine component.

### TECHNICAL FIELD

The technology relates to masking devices used during the manufacturing or servicing of turbine components, such as blades or vanes for a gas turbine. In particular, the technology relates to a boot system that is affixed to the turbine component during a process to coat and/or grit blast the component.

### BACKGROUND

Turbine components, such as a turbine blades (also referred to as airfoils) or vanes, in a gas turbine are typically subjected to stress from centrifugal force and fluid forces that can cause fracture, yielding, or creep failures. In addition, turbine components often endure temperatures around 2,500 °F (1,370 °C). Such high temperatures can weaken the turbine components and make them more susceptible to creep and corrosion failures. Also, vibrations from the turbine itself can cause fatigue failures.

One solution employed to improve the durability of and protect turbine components is to add a protective coating to component surfaces. For example, thermal barrier coatings, such as high temperature corrosion resistant metallic coatings.

In one coating process, multiple turbine components are positioned at a perimeter of a disc, and a nozzle is positioned at the center of the disc. The nozzle is attached to a storage supply for the protective coating and rotates to spray the protective coating on the turbine components. To prevent the protective coating, grit, and/or foreign material from clogging cooling holes in the turbine component during the coating process, portions of each turbine component are masked.

Masking each turbine component is achieved by adhering one or more protective sheets or tape to the turbine component. Each sheet or tape is trimmed to a particular shape matching the surface being covered by the sheet. Once the turbine component is coated, the masking material is removed from the turbine component and disposed of.

There are substantial inefficiencies with the current process. For example, the protective sheets or tape are single use. Thus, a unique mask for each turbine component must be prepared for each performance of the coating process, which increases the amount of time needed for preparation. In addition, the turbine components must be manually spaced apart which also increases the time for preparation and is susceptible to inconsistent spacing between turbine components, which can reduce the capacity of the disc. Also, under the current process, the edges of the turbine components remain exposed, which often results in overspray that requires additional processing of the turbine components to remove the excess coating material.

A masking system is desired that better masks the turbine components to increase the efficiency of the coating process and prevents overspray.

### SUMMARY

Disclosed herein are a system and method that may be applied to solve the problems discussed above.

In one aspect of the technology, a masking and support system for a turbine component includes a first resiliently flexible boot configured to cover a first portion of the turbine component, the first resiliently flexible boot comprising a concave outer surface and a convex inner surface opposite the outer surface and configured to engage the first portion of the turbine component; and a second resiliently flexible boot configured to cover a second portion of the turbine component, the second resiliently flexible boot comprising a convex outer surface and a concave inner surface opposite the outer surface and configured to engage the second portion of the turbine component.

A further aspect of the technology includes the preceding aspect and wherein the first resiliently flexible boot is configured to cover a plurality of cooling openings in the turbine component.

A further aspect of the technology includes any of the preceding aspects and wherein the first and second resiliently flexible boots are made of silicone.

A further aspect of the technology includes any of the preceding aspects and wherein the first resiliently flexible boot comprises a pair of securing members on opposite sides of the convex inner surface, each of the securing members being configured to wrap around a portion of the turbine component.

A further aspect of the technology includes any of the preceding aspects and wherein the pair of securing members are flexible flanges.

A further aspect of the technology includes any of the preceding aspects and wherein the first and second resiliently flexible boots are configured to support the turbine component at a predetermined height.

A further aspect of the technology includes any of the preceding aspects and wherein the first and second resiliently flexible boots are configured so that when the first and second resiliently flexible boots are secured to the turbine component, the concave outer surface of the first resiliently flexible boot faces a first direction and the convex outer surface of the second resiliently flexible boot faces a second direction opposite the first direction.

A further aspect of the technology includes any of the preceding aspects and wherein the radius of curvature of the concave outer surface of the first resiliently flexible boot is smaller than the radius of curvature of the convex outer surface of the second resiliently flexible boot.

A further aspect of the technology includes any of the preceding aspects and a system for applying a protective coating or a stream of grit blasting particles on a turbine component. The system includes a platform with a receiving area bound by an inner rim and an outer rim; the first and second resiliently flexible boots according to any of the preceding aspects; and a nozzle configured to discharge a stream of fluid or particles toward the receiving area, wherein the first and second resiliently flexible boots are configured to be received within the receiving area.

A further aspect of the technology includes any of the preceding aspects and wherein the platform is a disc and the inner and outer rims form concentric circles.

A further aspect of the technology includes any of the preceding aspects and wherein the platform is rotatable.

A further aspect of the technology includes any of the preceding aspects and wherein the platform is configured to rotate at a speed within a range of about 40 rpm to about 50 rpm.

A further aspect of the technology includes any of the preceding aspects and wherein the concave outer surface of the first resiliently flexible boot is configured to abut the inner rim when the first resiliently flexible boot is positioned in the receiving area.

A further aspect of the technology includes any of the preceding aspects and wherein the convex outer surface of the second resiliently flexible boot is configured to abut the outer rim when the second resiliently flexible boot is in the receiving area.

A further aspect of the technology includes any of the preceding aspects and wherein the nozzle is configured to rotate.

A further aspect of the technology includes any of the preceding aspects and wherein the nozzle is configured rotate at a speed within a range of about 40 rpm to about 50 rpm.

A further aspect of the technology includes any of the preceding aspects and wherein the nozzle is configured to discharge a protective coating.

A further aspect of the technology includes any of the preceding aspects and wherein the nozzle is configured to discharge a stream of grit blasting particles.

A further aspect of the technology includes any of the preceding aspects and wherein the first and second resiliently flexible boots are configured to automatically align the turbine component in a target orientation for receiving the protective coating upon being placed in the receiving area of the platform.

A further aspect of the technology includes any of the preceding aspects and wherein the radius of curvature of the concave outer surface of the first resiliently flexible boot is smaller than the radius of curvature of the convex outer surface of the second resiliently flexible boot.

### BRIEF DESCRIPTION OF THE DRAWINGS

FIG. 1 illustrates a perspective view of a protective coating application system for a turbine component.

FIG. 2 is a perspective view of the platform of the protective application coating system of FIG. 1.

FIG. 3 is a perspective view of a workpiece assembly.

FIG. 4 is an exploded view of the workpiece assembly of FIG. 3.

FIG. 5 is a perspective view of a first boot of the workpiece assembly of FIGS. 3 and 4.

FIG. 6 is a perspective view of a second boot of the workpiece assembly of FIGS. 3 and 4.

### DETAILED DESCRIPTION OF EXAMPLE NON-LIMITING EMBODIMENTS

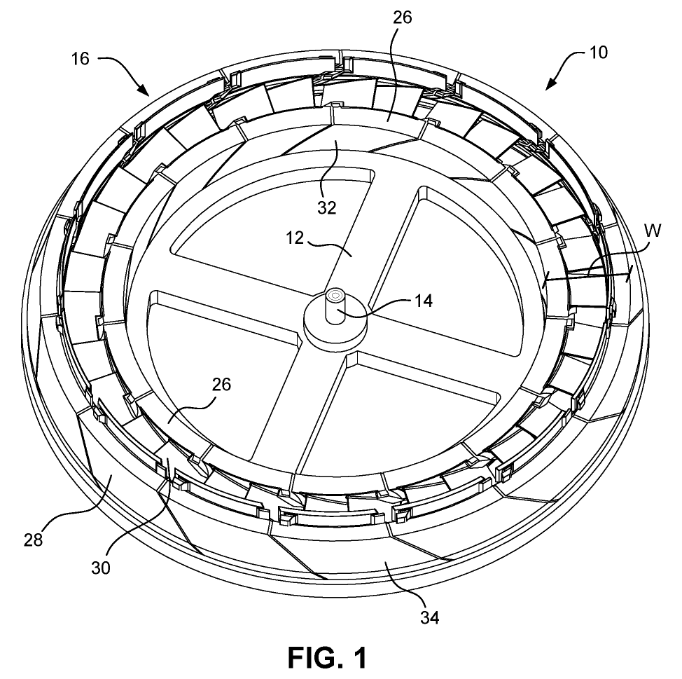

FIG. 1 illustrates an exemplary turbine component coating system 10. The coating system 10 may include a platform or table 12, a nozzle 14 located at the center of the platform 12, and a plurality of workpiece assemblies 16.

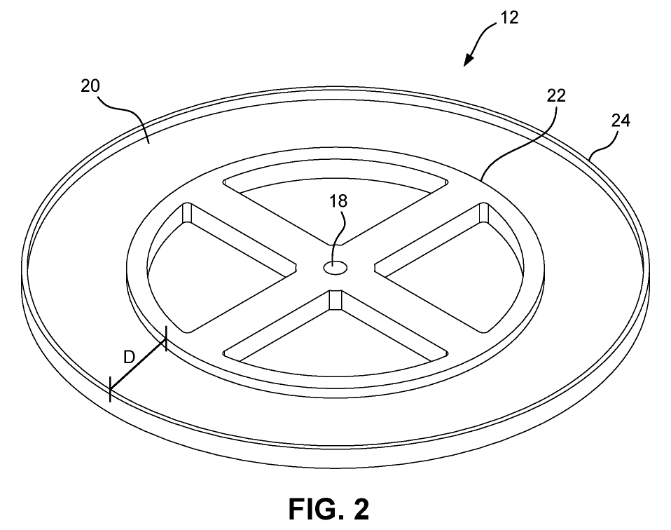

As illustrated in FIG. 2, the platform 12 may have a disc shape with an opening 18 in the center that receives the nozzle 14. The platform 12 may also include a receiving area 20 that receives multiple workpiece assemblies 16. The platform 12 may be made of a metal or plastic or any other material that is both rigid and capable of withstanding the environmental conditions associated with the thermal coating process.

The nozzle 14 may extend through the opening 18 from below the platform 12 and may be fluidly connected to a supply of a thermal coating solution. The nozzle 14 may be rotatable relative to the platform 12 so that the nozzle 14 may spray the thermal coating radially outward in a 360 degree range. It is contemplated that the platform 12 may be stationary and that the nozzle 14 may be rotatable or the platform 12 may be rotatable and the nozzle 14 may be stationary. Alternatively, the platform 12 and the nozzle 14 may each be rotatable in opposite directions. It is contemplated that the nozzle 14 and/or the platform 12 may rotate at a speed within a range of about 40 rpm to about 50 rpm.

It is also contemplated that the temperature of the thermal coating flowing from the nozzle 14 may be about 200 to 300 degrees Fahrenheit. In addition, the nozzle 14 may be configured to spray a stream of thermal coating and/or a stream of grit blasting.

The receiving area 20 may be bound by an inner rim 22 and an outer rim 24 so that the receiving area 20 is in the form of a channel or recess. It is contemplated that the height of the inner rim 22 and the height of the outer rim 24 (as measured from the surface on which the workpiece assemblies 16 rest) may be within a range of about 0.25 inches to about 3 inches. For example, the height of both the inner rim 22 and the outer rim 24 may be about 1 inch. It is further contemplated that the height of the inner rim 22 may be the same as the height of the outer rim 24. Alternatively, the inner and outer rims 22, 24 may have different heights. The distance D from the inner rim 22 to the outer rim 24 may be substantially equivalent to a width W of the workpiece assemblies 16. This way, the inner and outer rims 22, 24 may cooperate to allow little or no radial movement of the workpiece assembly 16 while the workpiece assembly 16 is positioned in the receiving area 20 on the platform 12.

Each workpiece assembly 16 may include a first (inner) boot 26, a second (outer) boot 28, and a turbine component 30 sandwiched between the first and second boots 26, 28. The first and second boots 26, 28 may support and align the turbine component 30 on the platform 12. As can be seen in FIG. 1, each inner boot 26 may have a concave inner surface 32 that abuts the convex surface of the inner rim 22 when the workpiece assembly 16 is positioned in the receiving area 20. Accordingly, the radius of curvature of the concave inner surface 32 may be substantially the same as the radius of curvature of the concave surface of the inner rim 22.

In addition, each outer boot 28 may have a convex outer surface 34 that abuts the concave surface of the outer rim 24 when the workpiece assembly 16 is positioned in the receiving area 20. The radius of curvature of the convex outer surface 34 may be substantially the same as the radius of curvature of the concave surface of the outer rim 24. It is contemplated that the curvature of radius of the outer rim 24 may be within a range of about 10 inches to about 15 inches (e.g., 13, 13.1425, or 14 inches).

As can be seen in FIGS. 1 and 2, the inner and outer rims 22, 24 form concentric circles. Accordingly, the radius of curvature of the concave surface of the outer rim 24 is larger than the convex surface of the inner rim 22. Similarly, the radius of curvature of the convex outer surface 34 is larger than the radius of curvature of the concave inner surface 32.

While the inner and outer rims 22, 24 may radially align and position the workpiece assembly 16 a predetermined distance from the nozzle 14, the structures of the workpiece assemblies 16 themselves may align and position the workpiece assemblies 16 circumferentially around the nozzle 14. In particular, each inner and out boot 26, 28 may have angled side walls. In such a configuration, the concave inner surface 32 may have a parallelogram-like shape. That is, each set of opposing sides of the concave inner surface 32 may be parallel (i.e., the upper and lower sides may be parallel and the lateral sides may be parallel). In addition, the left lateral side of the concave inner surface 32 may form an acute angle with the bottom side that is equal to the angle formed between the upper and right lateral sides. In addition, the right lateral side of the concave inner surface 32 and the bottom side may form an obtuse angle that is equal to the angle formed between left lateral side of the concave inner surface 32 and the top side.

Similarly, the left lateral side of the convex outer surface 34 may form an acute angle with the bottom side that is equal to the angle formed between the upper and right lateral sides. In addition, the right lateral side of the convex outer surface 34 and the bottom side may form an obtuse angle that is equal to the angle formed between left lateral side of the convex outer surface 34 and the top side.

In this configuration, each inner boot 26 supports an adjacent inner boot 26 on one side and is supported by an adjacent inner boot 26 on the other side. Similarly, each outer boot 28 supports an adjacent outer boot 28 on one side and is supported by an adjacent outer boot 28 on the other side. In other words, each adjacent boot is interlocked with an adjacent boot. It is contemplated that the interlocking feature may have different geometries such as male and female components instead of angled side walls.

The inner and outer rims 22, 24 and the interlocking structure of adjacent workpiece assemblies 16 allows for a consistent positioning of the turbine component 30 relative to the nozzle by simply placing the workpiece assembly 16 in the receiving area 20 of the platform 12. In other words, the turbine component 30 is automatically aligned and positioned relative to the nozzle 14 by simply placing the workpiece assembly 16 in the receiving area 20 of the platform 12. In one exemplary configuration, when the workpiece assembly 16 is positioned in the receiving area 20 of the platform 12, the distance from the nozzle 14 to the first boot 26 may be about 4 to 8 inches (e.g., 6 inches).

In addition, because the side walls of the inner and outer boots 26, 28 have a predetermined thickness and because adjacent boots abut each other, the spacing between turbine components 30 may be consistent and may be automatically set by simply placing the workpiece assemblies 16 on the receiving area 20 of the platform 12. It is contemplated that the turbine components may be separated by a distance of 0.3 inches.

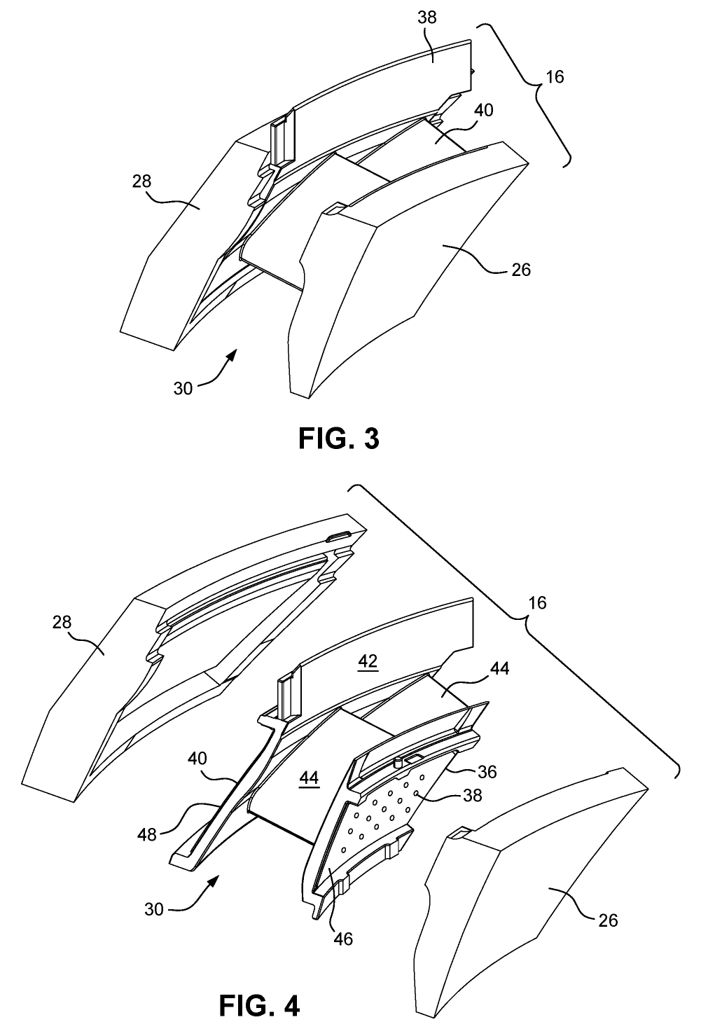

It is contemplated that the turbine component 30 may be in the form of a turbine blade, turbine vane, doublet vane assembly (which is the form illustrated in FIGS. 1, 3, and 4), or any other turbine component that is subjected to thermal spray coating process. The turbine component 30 may include an inner platform (or flange) 36 with a plurality of cooling holes 38. The turbine component 30 may also include an outer platform (or flange) 40 that opposes the inner platform 36. The outer platform 40 may include a shroud 42 that extends from the main body of the outer platform 40 in a circumferential direction. A plurality of vanes 44 bound by the inner and outer platforms 36, 40.

The turbine component 30 may be designed to be assembled with other turbine components 30 in a circular structure so that the inner platform 36 faces toward a center of the circular structure and the outer platform 40 faces away from the center of the circular structure. Accordingly, the inner platform 36 and the outer platform 40 may have curved surfaces. The curved surface 46 of the inner platform 36 may be the surface containing the cooling openings 38. The curved surface 48 of the outer platform 40 may be the surface that faces away from the inner platform 36 and the vanes 44. The curved surface 46 may be concave, while the curved surface 48 may be convex. In addition, the radius of curvature of the curved surface 46 may be smaller than the radius of curvature of the curved surface 48.

Referring back to FIG. 1, the first boot 26 may be positioned between the turbine component 30 (particularly the inner platform 36) and the nozzle 14. Accordingly, in addition to supporting and aligning the turbine component 30 relative to the nozzle 14, the first boot 26 may also mask the inner platform 36 and protect the cooling holes 38 from becoming clogged during the coating (or grit blasting) process.

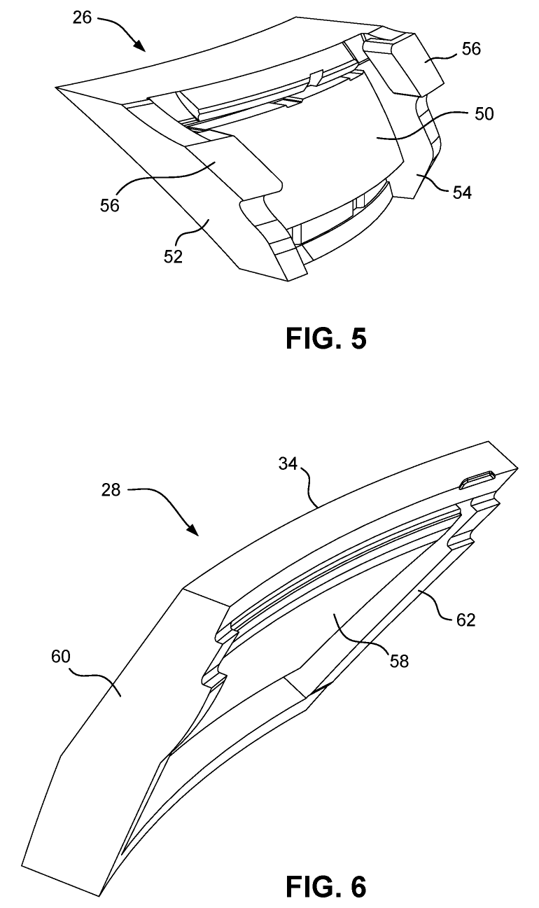

As illustrated in FIG. 5, the first boot 26 may have an engagement face 50 located between a first lateral wall 52 and a second lateral wall 54. The engagement face 50 may engage the curved surface 46 of the inner platform 36. Accordingly, the engagement face 50 may be convex to accommodate the concave shape of the curved surface 46. The engagement face 50 may also include one or more recesses that are sized and shaped so that when the engagement face 50 is in contact with the curved surface 46, the recesses receive flanges or other protrusions that project from the surface of the inner platform 36.

The first and second lateral side walls 52, 54 that engage the sides of the inner platform 36 and may each contain a respective securing mechanism 56. The securing mechanism may be in the form of a flange that wraps around the edges of the inner platform 36 to engage a rear side of the inner platform 36 that is opposite the concave curved surface 48. It is contemplated that the first boot 26 may be formed from an elastomeric material such as, for example, silicone. Accordingly, upon securing the first boot 26 to the inner platform 36, the first boot 26 may be pressed against the inner platform 36 so that the securing mechanisms 56 deform to allow the inner platform 36 to pass between them. Once the inner platform 36 is fully received by the first boot 26, the securing mechanisms 56 may return to their original form.

FIG. 5 shows the securing mechanisms 56 extending only part of the length of the side walls 52, 54. However, the securing mechanisms 56 may extend the entire length of the side walls 52, 54. Alternatively, the securing mechanisms 56 may be in the form of a snap fit connection, a strap, a mechanical fastener, or any other device that can secure the first boot 26 to the inner platform 26.

Referring back to FIG. 1, the second boot 28 may be positioned behind the turbine component 30 so that the turbine component 30 is between the second boot 28 and the nozzle 14. Because the turbine component 30 is between the second boot 28 and the nozzle 14, the second boot 28 does not mask or protect any part of the turbine component 30 from the stream discharged by the nozzle 14. Thus, the function of the second boot 28 is to support and position the turbine component 30 in a desired location and orientation.

As illustrated in FIG. 6, the second boot 28 may have an engagement face 58 located between a first lateral wall 60 and a second lateral wall 62. The engagement face 58 may engage the curved surface 48 of the outer platform 40. Accordingly, the engagement face 58 may be concave to accommodate the convex shape of the curved surface 48. The engagement face 58 may also include one or more recesses that are sized and shaped so that when the engagement face 58 is in contact with the curved surface 48, the recesses receive flanges or other protrusions that project from the surface of the outer platform 40.

The second boot 28 may be secured to the outer platform 40 of the turbine component 30 by way of an interference fit. That is, the second boot 28 may be made of elastomeric material such as, for example, silicone, which is deformable and can be sized and shaped to provide enough frictional force to be secured to the outer flange 40. Alternatively, the second boot 28 may include a mechanical fastener, a strap, a male/female connection, or any other device capable of securing the second boot 28 to the outer platform 40 so that the second boot 28 can support the turbine component 30.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or "comprising" do not exclude other elements or steps, the terms "a" or "one" do not exclude a plural number, and the term “or” means either or both, unless this application states otherwise. Also, the terms “approximately”, “about”, and “substantially” encompass a range of plus or minus 15%. Furthermore, characteristics or steps which have been described may also be used in combination with other characteristics or steps and in any order unless the disclosure or context suggests otherwise.

1. A masking and support system for a turbine component, the masking and support system comprising:
a first resiliently flexible boot configured to cover a first portion of the turbine component, the first resiliently flexible boot comprising a concave outer surface and a convex inner surface opposite the outer surface and configured to engage the first portion of the turbine component; and
a second resiliently flexible boot configured to cover a second portion of the turbine component, the second resiliently flexible boot comprising a convex outer surface and a concave inner surface opposite the outer surface and configured to engage the second portion of the turbine component.

2. The masking and support system of claim 1, wherein the first resiliently flexible boot is configured to cover a plurality of cooling openings in the turbine component.

3. The masking and support system of claim 1, wherein the first and second resiliently flexible boots are made of silicone.

4. The masking and support system of claim 1, wherein the first resiliently flexible boot comprises a pair of securing members on opposite sides of the convex inner surface, each of the securing members being configured to wrap around a portion of the turbine component.

5. The masking and support system of claim 4, wherein the pair of securing members are flexible flanges.

6. The masking and support system of claim 1, wherein the first and second resiliently flexible boots are configured to support the turbine component at a predetermined height.

7. The masking and support system of claim 1, wherein the first and second resiliently flexible boots are configured so that when the first and second resiliently flexible boots are secured to the turbine component, the concave outer surface of the first resiliently flexible boot faces a first direction and the convex outer surface of the second resiliently flexible boot faces a second direction opposite the first direction.

8. The masking and support system of claim 1, wherein the radius of curvature of the concave outer surface of the first resiliently flexible boot is smaller than the radius of curvature of the convex outer surface of the second resiliently flexible boot.

9. A system for applying a protective coating or a stream of grit blasting particles on a turbine component, the system comprising:
a platform with a receiving area bound by an inner rim and an outer rim;
the first and second resiliently flexible boots of claim 1; and
a nozzle configured to discharge a stream of fluid or particles toward the receiving area,
wherein the first and second resiliently flexible boots are configured to be received within the receiving area.

10. The system of claim 9, wherein the platform is a disc and the inner and outer rims form concentric circles.

11. The system of claim 9, wherein the platform is rotatable.

12. The system of claim 11, wherein the platform is configured to rotate at a speed within a range of about 40 rpm to about 50 rpm.

13. The system of claim 9, wherein the concave outer surface of the first resiliently flexible boot is configured to abut the inner rim when the first resiliently flexible boot is positioned in the receiving area.

14. The system of claim 13, wherein the convex outer surface of the second resiliently flexible boot is configured to abut the outer rim when the second resiliently flexible boot is in the receiving area.

15. The system of claim 9, wherein the nozzle is configured to rotate.

16. The system of claim 15, wherein the nozzle is configured to rotate at a speed within a range of about 40 rpm to about 50 rpm.

17. The system of claim 9, wherein the nozzle is configured to discharge a protective coating.

18. The system of claim 9, wherein the nozzle is configured to discharge a stream of grit blasting particles.

19. The system of claim 9, wherein the first and second resiliently flexible boots are configured to automatically align the turbine component in a target orientation for receiving the protective coating upon being placed in the receiving area of the platform.

20. The system of claim 9, wherein the radius of curvature of the concave outer surface of the first resiliently flexible boot is smaller than the radius of curvature of the convex outer surface of the second resiliently flexible boot.
